(19) United States
(12) Patent Application Publication
(10) Pub. No.: US 2005/0126344 A1
(43) Pub. Date: Jun. 16, 2005

(54) Bottle opener with display surface

(76) Inventor: Joseph P. Jones, Lake Ariel, PA (US)

Correspondence Address: SYNNESTVEDT & LECHNER, LLP, 2600 ARAMARK TOWER, 1101 MARKET STREET, PHILADELPHIA, PA, 191072950, US

(21) Appl. No.: 10/736,403

(22) Filed: Dec. 15, 2003

(51) Int. Cl. B67B 7/16

(52) U.S. Cl. 81/3.55

(57) ABSTRACT

A ring for removing bottle caps from bottles and which is wearable on a finger is disclosed. The ring has a circumferential band defining an opening for receiving a finger. A lower portion of the band has an edge that engages the bottle cap. An upper portion of the band opposite the lower portion forms a finger engaging projection that extends axially beyond the cap engaging edge and distributes the forces along the finger resulting when the cap is pried from the bottle by curling the finger. The cap engaging edge is positioned on an axially projecting tab. The finger engaging projection has an outwardly facing surface useful for the display of indicia.

### FIELD OF THE INVENTION

This invention concerns bottle openers in the form of a wearable ring.

### BACKGROUND OF THE INVENTION

It is convenient to have a bottle opener close to hand when enjoying bottled beverages. Openers tend to become misplaced, however, especially during outdoor activities such as picnics or sporting events. Furthermore, efficiency of bartenders or wait staff may be improved if a bottle opener is used which may be worn on the hand and yet not interfere with other tasks performed by the person. If an opener is wearable, then the wasted motion of reaching for a separate opener when a bottled beverage is served may be avoided.

### SUMMARY OF THE INVENTION

The invention concerns a ring for removing a cap from a bottle. The ring is wearable on a finger and comprises a circumferential band defining an axially oriented opening for receiving the finger. The band has a first band portion positionable on one side of the finger, the first band portion having an axially facing edge positioned at one end of the band. The edge is engageable with the cap for removal thereof from the bottle by applying a prying action with the finger. The band further has a second band portion positioned substantially opposite the first band portion. The second band portion has a greater width than the first band portion for engaging an opposite side of the finger and distributing forces along the finger resulting from the prying action.

Preferably, the ring has a tab mounted on the first band portion at the one end. The tab extends outwardly in an axial direction from the edge, the cap engaging edge being positioned along the tab.

Preferably, the second band portion includes an outwardly facing surface adapted to display indicia thereon. The indicia may be embossed or engraved or mounted on the surface.

### BRIEF DESCRIPTION OF THE DRAWINGS

FIG. 1 is a perspective view of a ring bottle opener according to the invention in use;

FIG. 2 is a perspective view, on an enlarged scale, of the ring bottle opener shown in FIG. 1;

FIGS. 3, 3A and 3B are bottom side views taken at line 3-3 of FIG. 2 and showing various embodiments of the ring according to the invention; and

FIG. 4 is a side view of the ring in use opening a bottle.

### DETAILED DESCRIPTION OF THE EMBODIMENTS

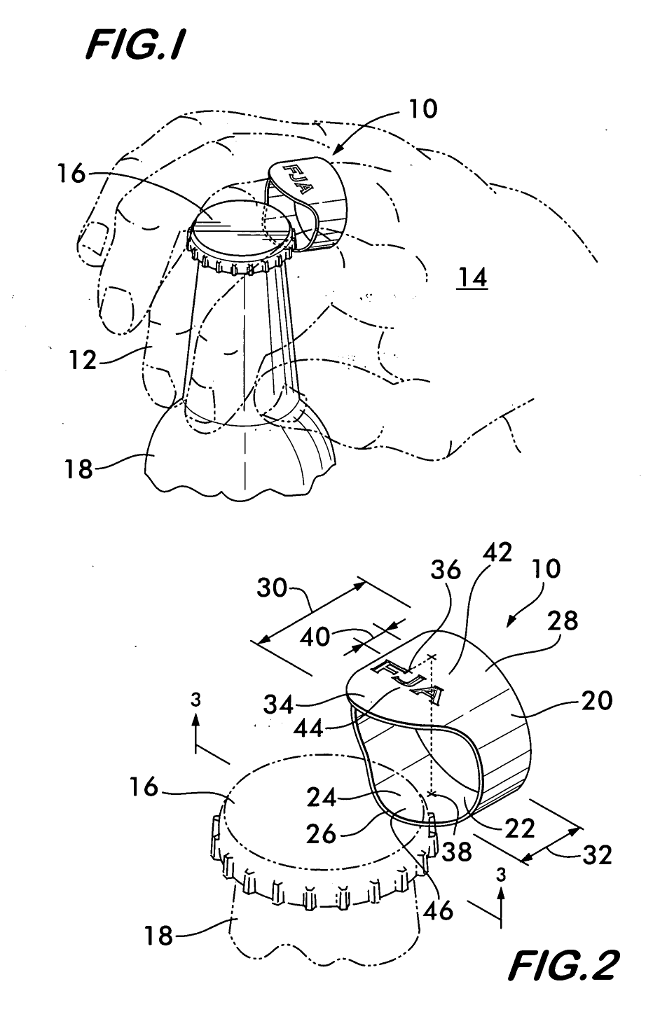

FIGS. 1 and 2 show a ring 10 wearable on a finger 12 of a hand 14 and adapted for removing a cap 16 from a bottle 18. Ring 10 comprises a circumferential band 20 that defines an axially oriented opening 22 for receiving finger 12. Band 20 has a lower band portion 24 that is positionable beneath finger 12. By “beneath” is meant on the side of the finger in the plane of the palm of hand 14. The lower band portion 24 has an axially facing edge 26 that is engageable with the cap 16 for removal thereof from bottle 18 by application of a prying action as described below.

Band 20 also has an upper band portion 28 positioned substantially opposite to the lower band portion 24. As best shown in FIG. 2, the upper band portion 28 has a greater width 30 than the width 32 of the lower band portion 24. The greater width 30 of the upper band portion 28 allows it to form a finger engaging projection 34 extending toward the tip of the finger axially beyond the axially facing cap engaging edge 26 of the lower band portion 24. The extension of projection 34 relative to the lower band portion 24 is evidenced by a comparison of the location of center 36 of the upper band portion 28 with the location of center 38 of the lower band portion 24. The centers 36 and 38 are measured axially along the upper and lower band portions 28 and 24 respectively. When the centers are projected to lie next to each other as shown in FIG. 2, there is an offset 40 between them in the axial direction. The relatively wide finger engaging projection 34 formed by upper band portion 28 provides for effective distribution of forces along the finger resulting from the prying action during cap removal. This allows the cap to be removed comfortably without bruising the finger on which the ring 10 is worn.

Upper band portion 28 also has an outwardly facing surface 42 adapted to display indicia 44. Indicia 44 may comprise, for example, letters, numbers, symbols or illustrations and can be, for example, a trademark, a service mark or other device having promotional or symbolic significance. The indicia 44 may be affixed in any manner to the surface 42, for example, by embossing, engraving, mounting or via a decalcomania.

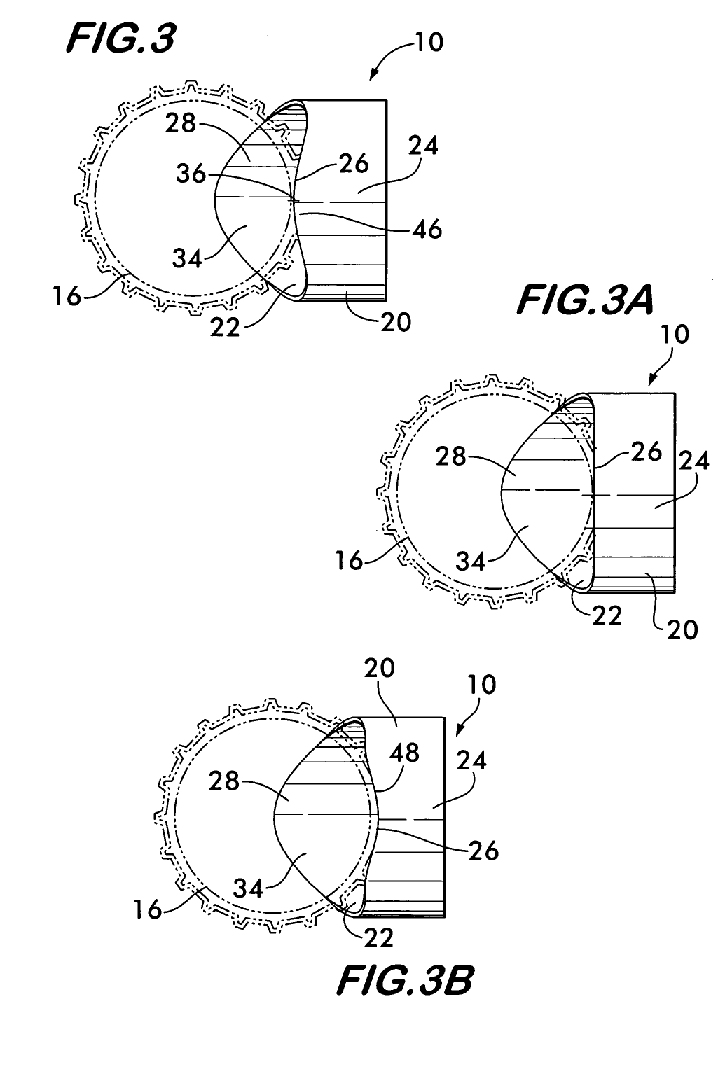

Various embodiments of ring 10 are displayed in FIGS. 3, 3A and 3B. In the preferred embodiment, shown in FIG. 3, cap engaging edge 26 is positioned along a tab 46 mounted on the lower band portion 24 and extending axially outwardly therefrom. In extending axially, tab 46 facilitates engagement of the edge 26 beneath the cap 16. As noted above, the finger engaging projection 34 extends beyond the cap engaging edge 26 even when edge 26 is positioned on the tab 46. In a particular example, the edge 26 is approximately diametrically opposite the center point 36 of the upper band portion 28.

FIG. 3A illustrates an embodiment of ring 10 wherein the edge 26 is not positioned on an axially projecting tab but is formed by the circumference of the lower band portion 24. FIG. 3B shows edge 26 along a notch 48 in the lower band portion 24. Preferably, notch 48 has a curvature sized to accommodate the cap 16.

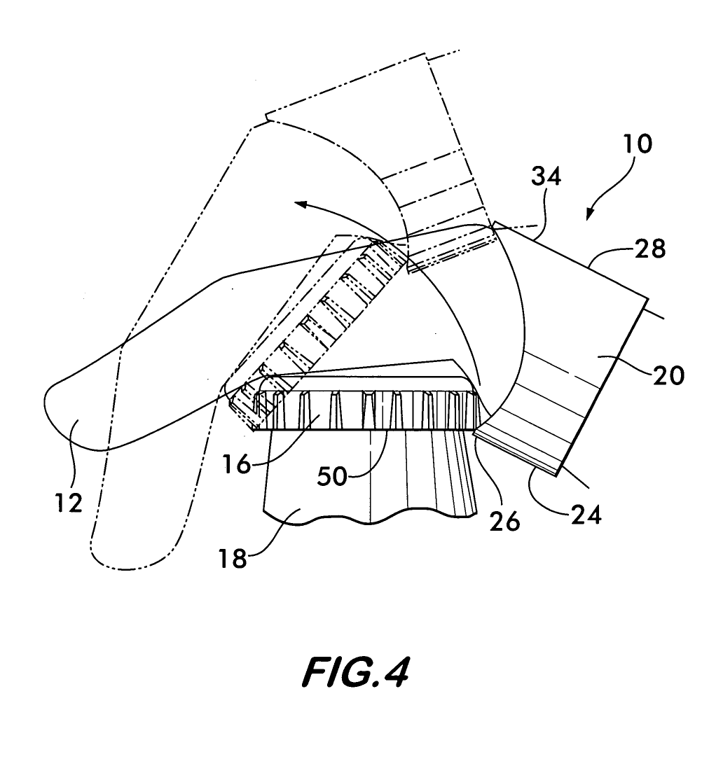

Operation of ring 10 is best shown in FIGS. 1 and 4. Ring 10 is worn on a finger 12 with the lower band portion positioned beneath the finger. Any finger is feasible, but the index or middle fingers are preferred because they can usually develop greater strength than the other fingers. The axially facing edge 26 is next engaged beneath the radially extending rim 50 of cap 16 by placing the hand 14, palm down over the cap 16. Next, as shown in FIG. 4, prying action is applied by curling the finger 12 to raise cap 16 off of bottle 18.

Ring 10, according to the invention, provides a convenient device for opening bottles easily, without injury or discomfort to the user and which is less readily misplaced than other opener devices.

1. A ring for removing a cap from a bottle, said ring being wearable on a finger and comprising a circumferential band defining an axially oriented opening for receiving said finger therethrough, said band having a first band portion positionable on one side of said finger, said first band portion having an axially facing edge positioned at one end of said band, said edge being engageable with said cap for removal thereof from said bottle by applying a prying action with said finger thereto, said band further having a second band portion positioned substantially opposite said first band portion, said second band portion having a greater width than said first band portion for engaging an opposite side of said finger and distributing forces along said finger resulting from said prying action.

2. A ring according to claim 1, further comprising a tab mounted on said first band portion at said one end and extending outwardly in an axial direction therefrom, said cap engaging edge being positioned along said tab.

3. A ring according to claim 1, further comprising a notch positioned along said first band portion at said one end thereof, said cap engaging edge being positioned along said notch.

4. A ring according to claim 3, wherein said notch has a curvature sized to accommodate said cap.

5. A ring according to claim 1, wherein said first and second band portions each have respective center points measured axially along said band, said center point of said second band portion being axially offset from said center point of said first band portion.

6. A ring according to claim 5, wherein said center point of said second band portion is approximately diametrically opposite to said cap engaging edge of said first band portion.

7. A ring according to claim 1, wherein said second band portion includes an outwardly facing surface adapted to display indicia thereon.

8. A ring according to claim 7, wherein said indicia are embossed on said surface.

9. A ring according to claim 7, wherein said indicia are mounted on said surface.

10. A ring according to claim 7, wherein said indicia are engraved on said surface.

11. A ring for removing a cap from a bottle, said ring being wearable on a finger and comprising a circumferential band defining an axially oriented opening for receiving said finger therethrough, said band having a first band portion positionable on one side of said finger, said first band portion having a tab extending axially outwardly from one end of said band, said tab having an axially facing edge engageable with said cap for removal thereof from said bottle by applying a prying action with said finger thereto, said band further having a second band portion positioned substantially opposite said first band portion, said second band portion having a greater width than said first band portion for engaging an opposite side of said finger and distributing forces along said finger resulting from said prying action.

12. A ring according to claim 11, wherein said first and second band portions each have respective center points measured axially along said band, said center point of said second band portion being axially offset from said center point of said first band portion.

13. A ring according to claim 12, wherein said center point of said second band portion is approximately diametrically opposite to said cap engaging edge of said first band portion.

14. A ring according to claim 11, wherein said second band portion includes an outwardly facing surface adapted to display indicia thereon.

15. A ring according to claim 14, wherein said indicia are embossed on said surface.

16. A ring according to claim 14, wherein said indicia are mounted on said surface.

17. A ring according to claim 14, wherein said indicia are engraved on said surface.

18. A ring for removing a cap from a bottle, said ring being wearable on a finger and comprising a circumferential band defining an axially oriented opening for receiving said finger therethrough, said band having a first band portion positionable on one side of said finger, said first band portion having a tab extending axially outwardly from one end of said band, said tab having an axially facing edge engageable with said cap for removal thereof from said bottle by applying a prying action with said finger thereto, said band further having a second band portion positioned substantially opposite said first band portion, said second band portion having a greater width than said first band portion an opposite side of said finger side of said finger opposite said first band portion and distributing forces along said finger resulting from said prying action, said first and second band portions each having respective center points measured axially along said band, said center point of said second band portion being axially offset from said center point of said first band portion.

19. A ring according to claim 18, wherein said center point of said second band portion is approximately diametrically opposite to said cap engaging edge of said first band portion.

20. A ring according to claim 18, wherein said second band portion includes an outwardly facing surface adapted to display indicia thereon.

21. A ring according to claim 20, wherein said indicia are embossed on said surface.

22. A ring according to claim 20, wherein said indicia are mounted on said surface.

23. A ring according to claim 20, wherein said indicia are engraved on said surface.

24. A ring for removing a cap from a bottle, said ring being wearable on a finger and comprising a circumferential band defined by first and second edges, said band having a cap engaging portion along said first edge, said cap engaging portion being positionable beneath a finger inserted within said ring and being engageable with said cap for removal of the cap from the bottle by application of a prying action by said finger, said band having a finger engaging projection extending from said first edge toward the tip of the finger axially beyond said cap engaging portion, said projection being disposed opposite to said cap engaging portion and being engageable with the upper surface of the finger for distributing prying forces along said finger resulting from said prying action.

25. A ring according to claim 24, further comprising a tab mounted on said first edge and extending outwardly in an axial direction therefrom, said cap engaging portion being positioned along said tab.

26. A ring according to claim 24, wherein said finger engaging projection has an outwardly facing surface adapted to display indicia thereon.

27. A ring according to claim 26, wherein said indicia are embossed on said surface.

28. A ring according to claim 26, wherein said indicia are mounted on said surface.

29. A ring according to claim 26, wherein said indicia are engraved on said surface.
